(19) United States
(12) Patent Application Publication
(10) Pub. No.: US 2005/0048263 A1
(43) Pub. Date: Mar. 3, 2005

(54) Reflective surface for a vehicle weatherseal

(75) Inventors: Peter Robert Ford, Midway Swadlincote (GB); William Whitehead, Maryville, TN (US)

Correspondence Address: Stephen B. Salai, Esq.;Harter, Secrest & Emery LLP, 1600 Bausch & Lomb Place, Rochester, NY, 14604-2711, US

(73) Assignee: Schlegel Corporation, New York City, NY (US)

(21) Appl. No.: 10/649,969

(22) Filed: Aug. 26, 2003

(51) Int. Cl. B32B 1/00

(52) U.S. Cl. 428/143; 264/167; 264/171.13

(57) ABSTRACT

A vehicle weatherseal includes a reflective surface, wherein the reflective surface can be located on a dynamic seal, a static seal or a trim portion of the weatherseal. The reflective surface can be extruded, molded, particulated, flocked or a colliquefied powder coating. The reflective surface can include a reflective matrix, reflective particles, or a reflective textile or fabric. The reflective surface can be incorporated in, or used with a friction reducing material to provide a friction reducing reflective dynamic seal.

### CROSS-REFERENCE TO RELATED APPLICATIONS

Not Applicable.

### STATEMENT REGARDING FEDERALLY SPONSORED RESEARCH OR DEVELOPMENT

Not Applicable. REFERENCE TO A ‘SEQUENCE LISTING”

Not Applicable.

### BACKGROUND OF THE INVENTION

1. Field of the Invention

The present invention relates to composite strips such as weatherseals and finishing strips, and more particularly, to a reflective surface for a vehicular weatherseal, wherein the reflective surface can include an extrusion, a molding, a cord, a textile, particles or a colliquefaction of a powder coating.

2. Description of Related Art

Composite strips are typically employed as weatherseals. These weatherseals must perform a variety of functions including the prevention of various contaminants such as moisture, dirt and debris from passing the seal. In motor vehicle applications, the weatherseal must also prevent road, engine, and wind noise from penetrating into a passenger compartment. Additionally, the weatherseal may include trim portions which consumers often demand be colored matched the vehicle.

In the motor industry, it is common practice to extrude sealing sections either from a black thermosetting polymeric material, which incorporates one or more fillers, or from a thermoplastic material. However, in each case, there is often a requirement for the extrusion to have its characteristics changed. For example, in order to stiffen the thermosetting polymeric material of a U-sectioned edge trim or door seal, a metallic carrier is incorporated within the extrusion.

The vehicle weatherseals are often located on moveable components of the vehicle, such as doors, hoods and trunks. The relative position of these components can be of significant concern to others such as vehicles passing by, cyclists and even pedestrians.

Therefore, a need exists for a weatherseal that can assist in signaling a location of a corresponding vehicle component. A need also exists for a method of manufacturing seals that can exhibit reflective surfaces. The need also exists for a surface film that can provide reflective properties in conjunction with sealing and aesthetic functions.

### BRIEF SUMMARY OF THE INVENTION

The present invention includes a composite strip such as a vehicular weatherseal, wherein the composite strip has an integral reflective surface. The composite strip can be a unitary structure of a reflective extrudate on a weatherseal body, wherein the weatherseal can be a dynamic seal or a static seal. Further, the reflective extrudate can be located on a dynamic sealing portion or a static sealing portion of the weatherseal.

Alternatively, the reflective surface can be formed by a variety of methods including reflective particles that are colliquefied on the weatherseal; reflective particles that are non melting and disposed in a melting matrix; and non-reflective particles in a powder form, which particles become reflective upon melting or colliquefaction.

In a further configuration, the reflective surface can be created by forming the entire weatherseal body, or portion of the weatherseal body from a reflective material, or from reflective particles disposed within a body forming matrix. It is also contemplated the reflective surface can be molded as a section of the weatherseal. The reflective surface can also be formed of a reflective element such as a cord having a single or a plurality of filaments or strands at least partially embedded within the weatherseal. A reflective flock can also be employed to form the reflective surface.

It is also contemplated the reflective surface can be a film to provide a colorable and flexible layer that can bond to a variety of substrates. The reflective surface film is formed from a powder coating, which can include thermoset, thermoplastic or both thermoset and thermoplastic materials. In addition, through the selection of the materials in the powder coating, the reflective surface film can provide a reduced co-efficient of friction.

The present invention can be incorporated into a resilient sealing structure such as a weatherseal, typically having a body and a sealing portion, wherein the reflective surface film is integrally bonded to at least one of the body or the sealing portion of the weatherseal. The reflective surface can also be applied to finishing strips such as flange finishers and trim strips.

Thus, the invention provides a reflective weatherseal, wherein the reflective portions of the weatherseal can include a dynamic seal, a static seal or a trim portion. The present reflective coating allows a portion of the weatherseal to be deformable and reflective.

### BRIEF DESCRIPTION OF THE SEVERAL VIEWS OF THE DRAWINGS

FIG. 1 is a perspective view of a vehicle showing a variety of locations of a weatherseal configuration of the composite strip having a reflective surface.

FIG. 2 is a cross-sectional view of a typical door seal including the reflective surface on the carrier portion, the sealing portion and the trim portion of the weatherseal.

FIG. 3 is a cross sectional view of a typical door seal including a reflective surface on the carrier portion.

FIG. 4 is a perspective view of a glass run channel configuration of the composite strip with a reflective surface.

FIG. 5 is a cross sectional view of a weatherseal such as a hood seal, having a carrier portion and a sealing portion including a reflective surface.

FIG. 6 is a cross sectional view of a weatherseal such as a belt line seal, having a reflective surface.

FIG. 7 is a cross sectional view of a representative deck lid seal, having a reflective surface.

FIG. 8 is a cross sectional view of a channel mounted seal having a reflective surface.

FIG. 9 is a schematic cross sectional view showing a plurality of reflective particles.

FIG. 10 is a schematic cross sectional view of a representative weatherseal having a reflective cord.

### DETAILED DESCRIPTION OF THE INVENTION

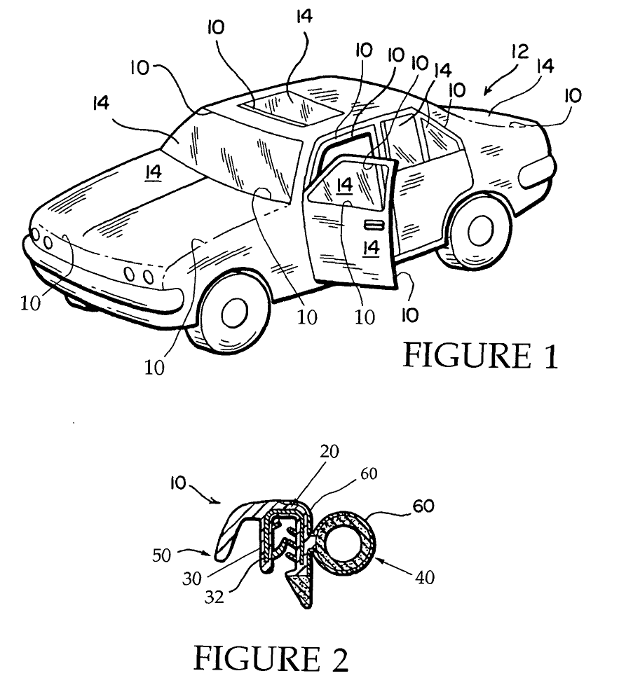

Referring to FIG. 1, the composite strip of the present invention can be employed as a weatherseal 10 in a motor vehicle 12. The weatherseal 10 can be used in a variety of locations for releasably and repeatedly engaging a panel 14. The composite strip is described as a weatherseal, however, it is understood the present invention can be employed in a trim or finishing application, which may not provide any sealing function. Thus, although the detailed description of the composite strip is directed to the sealing configuration such as a weatherseal 10, it is understood the same teachings can be applied to non-sealing configurations including trim or finishing strips.

Typically, the weatherseal 10 configuration of the composite strip is disposed between confronting surfaces such as panels 14. The panels 14 may be any of a variety of materials and do not limit the present invention. For example, the panel 14 may be glass, metal or a composite, which is painted, surface treated or bare. In the operating environment, the panel 14 can be brought repeatedly into and out of engagement with the weatherseal 10. Alternatively, the weatherseal 10 may be moved relative to the panel 14. In these configurations, the weatherseal 10 is a dynamic seal. That is, the panel 14 and the weatherseal 10 move relative to each other between a closed position and an open position. Further, the weatherseal 10 and the panel 14 may be located in a substantially fixed relationship. For example, the weatherseal 10 may be located about a fixed panel 14 such as a front or rear window. Thus, the weatherseal 10 forms a static seal.

The term weatherseal includes, but is not limited to, extrusions, moldings, edge pieces, glass guidance components, glass run channels, weather strips and seals including channel mount or pin type mounted seals. The weatherseal 10 may be used as a weather strip in structural sealing applications including residential and commercial buildings, marine vehicles as well as the motor vehicle industry. In the motor vehicle industry, the weatherseal configuration is suitable for use in many areas including, but not limited to, storage compartments, glass guidance components, glass run channels, door seals, roof rails, deck lids, hood to cowl seals, belt line seals, window seals, sun roof seals, van sliders, hatch backs, tonneau seals or window channel seals.

It is understood the composite strip can be constructed and operably located in a position that does not perform a sealing function. One example of such non-sealing application is a flange finisher, trim or trim piece. Typical flange finishers are disposed on a flange to provide an aesthetically pleasing appearance, as well as reduce the risks associated with an otherwise exposed flange.

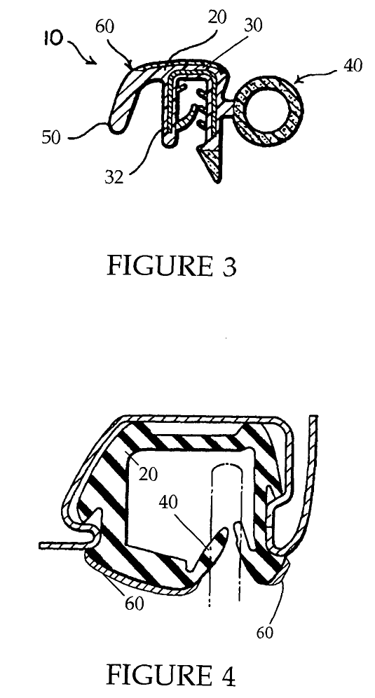

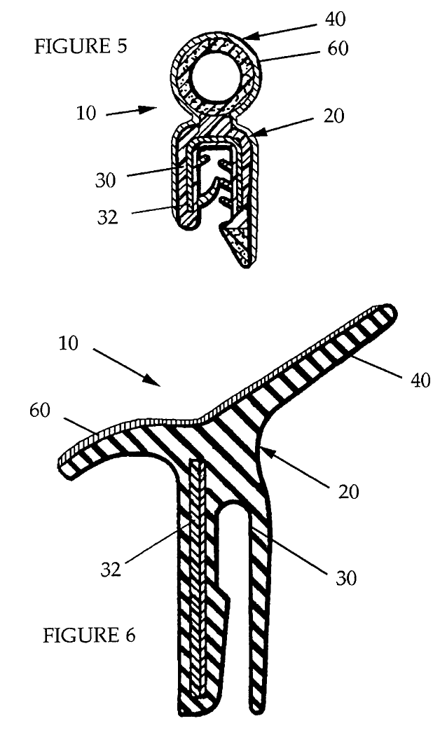

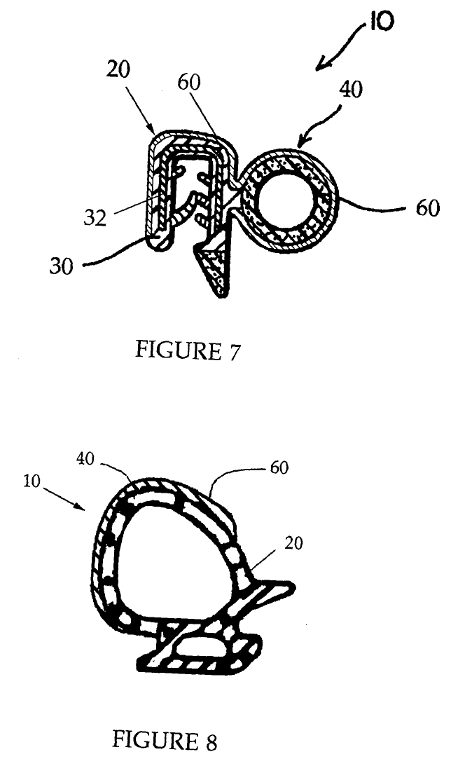

Referring to FIGS. 2-10, the weatherseal 10 includes a body 20 and a reflective surface 60.

Body

As seen in FIGS. 2, 3 and 10, the body 20 can include a carrier portion 30, a sealing portion 40 and a trim portion 50. However, referring to FIGS. 4-7, the body 20 can include only the carrier portion 30 and the sealing portion 40. Depending upon the operating environment, the sealing portion 40 can be a dynamic seal or a static seal.

Typically, the carrier portion 30 is the part of the body 20, which attaches the weatherseal 10 to one of the confronting surfaces. The carrier portion 30 can have any of a variety of configurations and typically forms a base or substrate to which the sealing portion 40 and/or the trim portion 50 are connected.

The carrier portion 30 can be formed of a variety of materials including plastic, thermoplastic or thermosetting materials, including but not limited to plastic, TPE, EPDM or any combination thereof. The thermoplastic materials can include polyethylene, EVA, PVC or polypropylene. Suitable vulcanized or cross-linked (thermosetting) polymeric materials include EPDM and modified EPDM.

The carrier portion 30 can have a relatively rigid section and a relatively soft or resilient section. That is, the carrier portion 30 can exhibit one or more durometer hardnesses. The carrier portion 30 can include a reinforcing member 32 such as a wire or metal carrier, which may be of known construction (such as knitted wire, lanced and stretched, slotted, solid (continuous) or stamped metal). It is also contemplated the carrier portion 30 can include a thermoplastic section and a thermoset section, wherein each section has a unique rigidity. Further, the carrier portion 30 can be formed at differing thicknesses to provide differing amounts of rigidity. It is contemplated the carrier portion 30 can have any of a variety of cross-sections, wherein typical cross-sections include “U” shaped, “J” shaped, “L” shaped or planar. As shown in FIGS. 2, 3, 5 and 6, the carrier portion 30 can have the U shaped profile with inwardly extending gripping fins for engaging one of the confronting surfaces.

Non sealing constructions of the present invention, such as the flange finisher, can be limited to a body 20 employing only the carrier portion 30, wherein the flange finisher can be operably retained by friction, fasteners or adhesives. The body 20 in the flange finisher configuration often has a U shaped cross section with at least one gripping fin for engaging the flange of the vehicle.

The sealing portion 40 is connected to the carrier portion 30 and typically extends from the carrier portion to contact the remaining confronting surface. The sealing portion 40 can have any of a variety of configurations including bulbs, flaps or fingers. The sealing portion 40 can be formed to have a different durometer, or rigidity than the carrier portion 30.

The sealing portion 40 can be constructed from a variety of polymeric materials, including but not limited to TPEs, thermoplastics and thermosets, wherein the materials can be solid, foamed, cellular or a sponge construction. Thus, the sealing portion 40 may have a lower density than the body. Typically, constructions incorporating a body 20 and a sealing portion 40 have one or both portions formed of a polymeric and often an elastomeric material. The sealing portion can function as a dynamic seal or a static seal. In a dynamic seal, the sealing portion 40 moves into and out of engagement with the panel 14. Typical dynamic seals includes glass run channels and door seals. In a static seal, the sealing portion 40 is generally fixed relative to the adjacent panel 14, and any relative movement typically results from flexing or stressing of the panel or the seal. Exemplary static seals are located about front and rear windows of a vehicle.

The trim portion 50 is typically connected to the carrier portion 30 and extends to overlay an adjacent part of the relevant confronting surface. Although the trim portion 50 is shown attached to the carrier portion 30, it is understood the trim portion can be connected to the carrier portion, the sealing portion 40 or both. The trim portion 50 is often formed of a different color or texture than the carrier portion 30 and the sealing portion 40. The trim portion 50 can also be formed of a variety of materials including thermoplastics, thermosets and composites. Thus, in the weatherseal configuration, each of the carrier portion 30, the sealing portion 40 and the trim portion 50 can be formed of different materials. Alternatively, the carrier portion can be any combination of materials among the carrier, sealing and trim portions.

The material forming the body 20, including any of the carrier portion 30, the sealing portion 40 or the trim portion 50 can be doped with a conductive filler to provide the necessary surface charge for attracting the powder coating to the surface. A typical conductive filler can include carbon black. Thus, the selected portion of the body 20 will exhibit a substantially different conductivity than the remaining portions of the body.

Reflective Surface

The reflective surface 60 can be formed in a variety of configurations. Generally, the reflective surface 60 is formed as a film, layer, flock, textile, cord or laminate, by any of a variety of processes, including but not limited to an extrusion, spray, sputter, molding or colliquefaction. The reflective surface 60 can be selectively formed to allow operable location on a sealing portion 40 of the weatherseal 10, in either static or dynamic seals.

The reflective surface 60 can be an extrudate, a reflective cloth extruded, or coextruded, with the corresponding portion of the weatherseal 10, or a preformed strip applied by extrusion. Textile includes but is not limited to woven, pile or cut fibers. Alternatively, the reflective surface can be formed from a colliquefaction. The extruded reflective surface 60 can be the exposed surface of the weatherseal. That is, the entire sealing portion 40 (or carrier portion 30 or trim portion 50) can be formed of a reflective material. The reflective surface 60 thus forms the exposed surface of the portion of the weatherseal 10.

It is also contemplated, the reflective surface 60 can be formed by a sufficiently high gloss surface, wherein the high gloss surface is an extruded material, or extruded preformed strip.

Depending upon the location of the reflective surface 60, the reflective surface can have a variety of thicknesses, such as a laminate. In addition, depending upon the location of the reflective laminate, the laminate can exhibit a variety of performance characteristics. That is, the reflective laminate can be relatively hard or soft, dense or cellular, flexible or rigid. For example, if the reflective laminate is disposed on the sealing portion 40, preferably the laminate has similar performance characteristics to the adjacent portions of the sealing portion 40.

The extruded reflective surface 60 is disposed on at least a portion of the weatherseal 10, such as the body 20, the sealing portion 40, or the trim portion 50. The reflective surface 60 can be extruded, or coextruded with the portion of the weatherseal 10 upon which the reflective surface is disposed. The reflective surface 60 can be located on a dynamic seal or a static seal. Further, the reflective surface 60 can be located on a dynamic portion or static portion of a given seal. The reflective surface 60 can also be located along selective regions or areas of the weatherseal 10. For example, the reflective surface 60 can be formed as longitudinally extending strips which are coplanar with the adjacent weatherseal, recessed from the adjacent weatherseal or raised relative to the adjacent weatherseal.

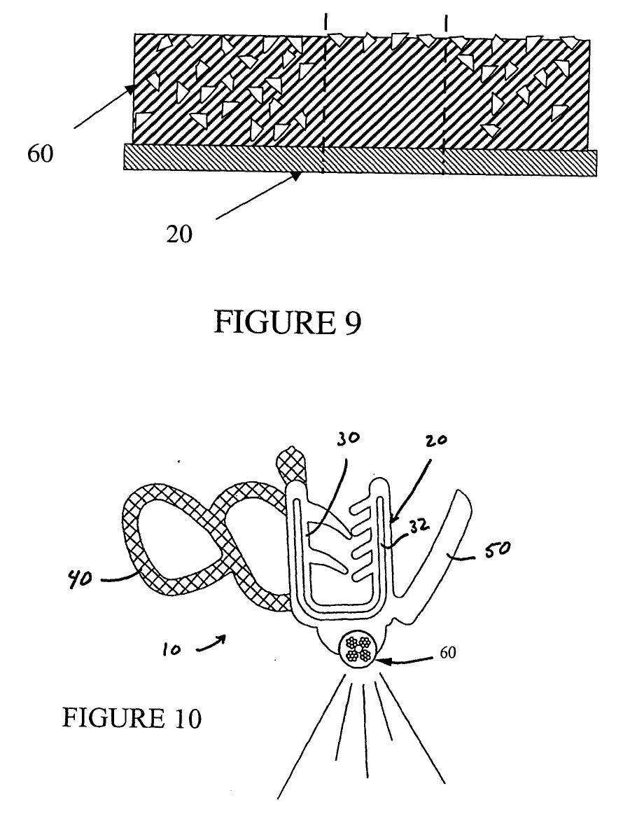

Referring to FIG. 9, the reflective extrudate forming the reflective surface 60 can include reflective particles within a non-reflective matrix. The reflective particles can include glass or plastic microspheres, particles, crushed particles, fractured particles or beads, which are reflective, refractive, reflex reflective, retroreflective, prismatic, externally coated, internally coated, fluorescent or photoluminescent. It is contemplated the reflective particles can be disposed within a non-reflective matrix, as well as on the surface of a non-reflective matrix. Alternatively, the entire extrudate can be formed of a generally reflective material. For example, a reflective thermoplastic, thermoplastic elastomer or thermoset can be extruded, without requiring the addition of the reflective particles.

The reflective surface 60 can also be a molded section of the body 20. Thus, the reflective surface 60 can be located at selected locations along a length of the weatherseal 10. For example, as the weatherseal 10 extends about a vehicle opening, the corners of the weatherseal can be molded to include the reflective surface 60. The molded section can define a portion or an entire cross section of the weatherseal. Further, the molded section can define a majority of the cross sectional area.

In a further configuration seen in FIG. 10, the reflective surface 60 can be defined by a cord at least partially embedded in the body 20. The cord can be a single filament or strand, or can include a plurality of filaments or strands. The cord can be embedded a sufficient distance to substantially preclude unintended separation, while providing sufficient exposed surface to exhibit reflection. It is contemplated that a single cord or a plurality of cords can be employed within a weatherseal.

In a further configuration, the reflective surface 60 is a reflective textile or a reflective flock. The reflective flock can be applied in selected locations to provide a reflective surface, as well as friction reducing surface.

In the colliquefaction configuration, which can include a contiguous colliquefaction, the reflective surface 60 is a film formed from a powder coating applied to the body 20 and subsequently melted to form a reflective surface and preferably continuous surface layer. Thus, the reflective surface 60 is a colliquefied powder coating forming a contiguous layer. Contiguous includes a single piece connected film, wherein continuous defines an uninterrupted contiguous film. Thus, the colliquefaction of the reflective surface 60 can provide a single piece, or sheet of material, as opposed to a plurality of discrete, unconnected sections. The reflective surface 60 is preferably bonded to the body 20 to preclude non-destructive separation. The powder coating forming the reflective surface film 60 can be disposed on any of the carrier portion 30, the sealing portion 40 or the trim portion 50. The reflective surface 60 can extend over any one, two or all three of the carrier portion 30, the sealing portion 40 or the trim portion 50. Further, the reflective surface 60 can be located at predetermined area of any one, or all three of the carrier portion 30, the sealing portion 40 or the trim portion 50.

In one configuration, the reflective surface 60 can be disposed over different portions of the weatherseal 10, which are formed of different materials. That is, for example, the reflective surface 60 can be operably bonded to a thermosetting carrier portion 30 and a TPE sealing portion 40. Thus, the reflective surface 60 can be located on different materials and form a single contiguous surface over the different materials. Conversely, a first powder coating can be applied to the weatherseal and colliquefied, whereupon a second powder coating can be applied to a second portion of the weatherseal and then colliquefied. The resulting weatherseal 10 can thus include a plurality of different reflective surfaces 60. It is also understood, different powder coatings can be applied to different areas of the body, such that the powder coatings are subsequently and simultaneously melted.

In certain constructions, the reflective surface 60 is a film having a thickness which is sufficiently small to provide flexibility in the film. The flexibility of the film forming the reflective surface 60 does not detrimentally reduce the flexibility of the underlying sealing portion 40. Thus, the film can conform with the sealing portion 40 during flexures of the sealing portion. However, it is understood the film forming the reflective surface film 60 can be selected according to the desired performance characteristics of the composite strip.

Extruded layers or surfaces are typically limited to achieving thicknesses greater than approximately 0.5 mm. In contrast, the film forming the reflective surface 60 has a thickness less than approximately 0.2 mm and preferably in the range of 0.05 mm to 0.20 mm. As discussed subsequently, the application process for the reflective surface 60 can be selected to render the thickness of the film substantially self-limiting. Thus, the film forming the reflective surface 60 provides a contiguous surface extending over a portion of the weatherseal. The film forming the reflective surface 60 can be formed of a sufficiently reduced thickness, such that upon being located on the sealing portion 40, the film does not reduce the resiliency or compliance of the sealing portion. However, it is understood the film forming the reflective surface film 60 can be formed to increase the rigidity of the underlying substrate.

Powder coatings are finely ground plastic particles including resin, a crosslinker in thermoset powders, pigments, extenders, and various flow additives and fillers to achieve specific properties. Powder coatings are applied as a dry material and when powder coating is heated, the particles colliquefy (melt) to form a contiguous film, which is typically very durable and chemical resistant.

Powder coating materials can be thermoplastic or thermoset. The thermoplastic powders do not chemically react in a cure phase during colliquefaction.

Thermoset powder coatings are applied and then cured, typically in an oven at a certain temperature for a certain time. The cure process will cause a chemical crosslinking to take place, changing the powder into a contiguous film that will not remelt.

The powder coatings can be formulated to meet a variety of appearance or performance characteristics, including the surface film thickness, gloss, texture, color, and performance (hardness, chemical resistance, UV resistance, temperature resistance. The powder coatings can be selected to provide very smooth finishes, hammertones, wrinkles, and metallics.

The powder coating can be formulated to create the film which is the reflective surface 60. That is, the reflective surface 60 can be formed from a powder coating so that incident light reflects from the reflective surface 60. That is, the film resulting from the powder coating can be reflective. The powder coatings can include glass or plastic microspheres, particles, crushed particles, fractured particles or beads, which are reflective, refractive, reflex reflective, retroreflective, prismatic, externally coated, internally coated, fluorescent or photoluminescent in combination with the film forming powder coating. It is contemplated the reflective particles can be disposed within a non-reflective powder coating.

The particle size of the powder coating can be controlled in response to the desired performance and appearance of the resulting reflective surface 60.

A thermoset powder coating for the reflective surface 60 can include a resin particle containing a thermosetting resin, and a particle containing a curing agent.

A thermosetting resin used in the powder coating can include epoxy resins, acrylic resins, phenol resins and polyester resins. These thermosetting resins can be used alone, or combined together with two or more kinds. In particular, a thermosetting resin having an epoxy group (that is, glycidyl group), such as epoxy resins, acrylic resins are available. These thermosetting resins have excellent reactivity to a curing agent comprising the curing particles, even at relatively low temperatures, for example, 120° C. or less.

A latent curing agent such as dicyandiamide, imidazolines, hydrazines, acid anhydrides, blocked isocyanates, and dibasic acids can be added to the resin particles as a curing promoter. The latent curing agent is typically stable at room temperature, and crosslinks with a thermosetting resin in a range of 140° C. to 260° C. It is understood any of a variety of cross-linking agents can be employed.

For thermoplastic or thermoset powder coatings, an additive or a function material can be added to the resin particles, such as a filler such as calcium carbonate, barium sulfate, talc; a thickener such as silica, alumina, aluminum hydroxide; a pigment such as titanium oxide, carbon black, iron oxide, copper phthalocyanine, azo pigments, condensed polycyclic pigments; a flowing agent such as silicone, acrylic oligomer such as butyl polyacrylate; a foam inhibitor such as benzoin; an accelerating agent such as zinc compounds; a wax such as polyolefin; a coupling agent such as silane coupling; an antioxidant; a wear characteristic enhancer such as high density polyethylene; a magnetic powder; a metal powder; or even an antimicrobial agent.

As the film forming the reflective surface 60 can be formed of a variety of materials including thermoplastic and thermoset, the reflective surface film can be selected to provide a variety of aesthetically pleasing colors to either match portions of the vehicle or provide distinct colors of the weatherseal. The reflective surface 60 can be selected to provide a high gloss, medium gloss or low gloss surface.

The use of a colliquefied powder coating to form the reflective surface film 60 allows the processing parameters to be maximized for the given component. That is, the processing (temperatures and pressures) of the body 20 do not need to accommodate the processing parameters of the powder coating to be liquefied.

Suitable powder coatings, as sold by Morton Powder Coating of Warsaw, Ind., include DG-5001 CORVELL® BLUE (ethylene/Acrylic), DG-7001 CORVEL® BLACK 20 (Ethylene/Acrylic), 78-7001 CORVEL® BLACK (Nylon) and 70-2006 CORVEL® YELLOW (Nylon), wherein the reflective particles are incorporated into the powder coating.

Alternatively, the powder coating can be a material that becomes or acquires reflectivity upon colliquefaction. That is, the material becomes reflective as a result of the heating and colliquefaction.

Manufacture

The particular method for providing the reflective surface 60 is at least partially determined by the materials of the weatherseal 10 and the desired characteristics of the weatherseal, and if a surface film is to be reflective, or the material of the body 20 is reflective.

In the extrusion process, a reflective extrudate is contacted with a surface of the weatherseal body, wherein the reflective extrudate forms the reflective surface 60.

The reflective extrudate can be formed in a variety of configurations. A polymeric matrix or carrier such as thermoplastics, thermoplastic elastomers or thermosets can be mixed with the reflective particles, as previously set forth. The mixture of the carrier and the reflective particles can be extruded, coextruded, simultaneously extruded or subsequently extruded with the weatherseal body 10, thereby forming the reflective extrudate.

It is also understood the mixture can include friction reducing materials or particles know in the art.

The reflective extrudate can be located on any of the dynamic or static portions of a weatherseal 10, as well as the static portion of the static seal. The reflective extrudate can be connected to the corresponding portion of the weatherseal body 20, by thermal bonding or mechanical interlocking. It is also contemplated that an adhesive can be used to augment or provide the bonding force between the reflective extrudate and the body 20.

The reflective extrudate can thus be located on the trim portion 50, the carrier portion 30 or the sealing portion 40, or any combination thereof. The reflective extrudate, and hence reflective surface, is thus integrally formed with the weatherseal, and is so formed to substantially preclude unintended separation. The reflective extrudate can also form the body 20.

Similarly, if the reflective extrudate is a reflective cloth (or textile), the extrudate can again be located on any portion(s) of the weatherseal.

The molded reflective surface 60 can be formed by molding methods known in the art, wherein the molded reflective material can define a portion of the cross section, such as the surface, or the entire cross section of the weatherseal 10. In a further configuration, the molded portion can define a majority of a given cross section of the weatherseal 10. The molding can include, but is not limited to an over molding.

The reflective cord can be located in a preformed channel in the weatherseal. Thus, the reflective cord can be incorporated in a subsequent process, or immediately downstream of formation of the channel. Alternatively, the cord can be integrated into the body 20 in an extrusion process, wherein the contact with the cord forms the channel.

Similarly, known flocking methods can be used to locate the reflective flock along the body 20. The flocking can be formed of a reflective material. Alternatively, the flocking can incorporate a reflective material. Thus, the reflective flocking can be formed to provide a reflective surface, or a friction reducing reflective surface.

As previously stated, the reflective particles can be incorporated into an extruded composition to form an integral or unitary structure. It is also understood the reflective particles can be sprayed, sputtered, impacted onto (into) the body to be retained in the body. Typically, such impacting is done when the body 20 is in a softened state. Alternatively, the particles can be impacted along with a bonding agent so as to bond the particles to the body 20. Further, a bonding agent can be previously disposed on the body 20, and the reflective particles are impacted against the bonding agent. The bonding agent can be a solvent based agent, a meltable agent, a curable agent or a combination thereof, including thermoset or thermoplastics which can be employed in conjunction with a solvent. As seen in FIG. 9, the particles can be homogeneously distributed throughout the layer 60, to be flush with the surface or project from the surface. Alternatively, the particles can be concentrated near the exposed surface and be flush or projecting.

Alternatively, the reflective surface 60 is the film formed by the colliquefaction of a powder coating, wherein the powder coating is temporarily retained on the weatherseal 10 and subsequently melted in place to form a reflective surface which can be contiguous. The powder coating can be temporarily disposed on the weatherseal 10 by a variety of mechanisms including bonding agents and electrostatic attraction.

The bonding agents can be incorporated into the powder coating, or applied to the weatherseal 10 in a desired location for the reflective surface film 60 prior to exposure of the body 20 to the powder coating.

Alternatively, and preferably, a surface charge is formed on selected portions of the body 20 and the powder coating particles are oppositely charged, such that upon exposure of the oppositely charged particles to the surface charged portions to the body, the powder coating is temporarily adhered. Subsequently, the colliquefaction (melting) steps, as determined by the composition of the powder coating and weatherseal, are employed to transform the powder coating into a contiguous reflective surface film 60.

As the elastomeric components of the body 20 are typically non-conductive, a potential is created between the surface of the body 20 and the powder coating. That is, a relative surface charge on the body 20 must be achieved. A number of mechanisms are contemplated for the formation of the necessary surface charge on the body 20.

For example, in those constructions of the carrier portion 30 having a metallic reinforcing member 32, a potential is applied to the reinforcing member. It has been found that a sufficient potential can be applied to the reinforcing member 32 to create a charge at the surface of the body 20 that is sufficiently strong to retain the powder coating prior to colliquefaction.

By controlling the electrical potential difference between the powder coating and the surface charge on the body 20, the amount of powder coating retained on the body can be controlled. As the amount of retained powder coating on the body 20 at least partially determines the thickness of the colliquefied reflective surface film 60, the thickness of the reflective surface film can be controlled by the electrical potential used to retain the powder coating on the body 20.

Thus, prior to fusing the powder coating, the weatherseal 10 has a heat fusible powder coating, wherein the resulting fused powder coating film is reflective.

The present invention provides a reflective polymer layer forming the reflective surface 60 affixed to the body 20, wherein the reflective polymer layer is affixed by heat bonding, such as during formation (colliquefaction).

The adhered powder coating is melted by a variety of options including radiative heat, conductive heat, radiation as well as solvents.

Thus, the powder coating forming the reflective surface 60 allows materials that were previously incompatible in a co-extrusion process, such as a thermoplastic polyamide (Nylon) and rubber, to be bonded upon formation of the surface layer 60. Preferably, the bonding is sufficient to preclude non-destructive separation of the contiguous surface film from the material underlying the surface film.

The ability to bond to previously incompatible materials allows for the use of a broader range of materials in the weatherseal 10.

Upon applying the powder coating by means of a spray, any over-spray of the powder coating can be collected and re-exposed to subsequent sections of the weatherseal. This reuse of the powder coating further reduces material costs.

Further, it is contemplated that through selection of the powder coating and formation of the reflective surface 60, shrinkage of the underlying body 20 may be inhibited. That is, the reflective surface 60 can provide a relatively high rigidity that inhibits shrinkage of the body 20.

The use of a powder coating and subsequent colliquefication and bonding to the body 20 allows the body to be formed pursuant to optimal conditions for the material of the body, without having to account for the processing considerations of the reflective surface film 60. The powder coating can be subsequently applied to the body 20 and melted to form the desired surface film 60, through either an on-line or off-line process.

The inherent incompatibility of processing parameters for thermoplastic and thermoset materials can be accommodated by the surface film 60. Specifically, the body 20 can be formed of the desired thermoset material to provide the necessary resiliency, wherein the formation process can be optimized for the thermoset material. After forming the body 20, the powder coating can be applied and melted pursuant to a different and optimized set of parameters.

While the invention has been described in connection with a presently preferred embodiment thereof, those skilled in the art will recognize that many modifications and changes can be made therein without departing from the true spirit and scope of the invention, which accordingly is intended to be defined solely by the appended claims.

1. A vehicle weatherseal for releasably contacting a panel, the weatherseal comprising:
(a) a panel contacting portion for releasably contacting the panel; and
(b) a reflective surface on the panel contacting portion.

2. The vehicle weatherseal of claim 1, wherein the reflective surface includes a multitude of reflective particles.

3. The vehicle weatherseal of claim 2, wherein the multitude of reflective particles form friction reducing projections.

4. The vehicle weatherseal of claim 1, wherein the panel contacting portion includes a substrate, the reflective surface being located on the substrate and the reflective surface having a lower coefficient of friction than the substrate.

5. The vehicle weatherseal of claim 1, further comprising a plurality of surface roughness forming friction reducing particles.

6. A reflective vehicular weatherseal, comprising:
(a) a polymeric substrate having a vehicle engaging portion and an exposed surface; and
(b) a multitude of reflective particles embedded in at least a portion of the exposed surface.

7. The reflective vehicular weatherseal of claim 6, wherein the particles are embedded a sufficient distance to preclude unintended separation from the polymeric substrate.

8. The reflective vehicular weatherseal of claim 6, further comprising a bonding agent intermediate a portion of the particles and the substrate.

9. An automotive weatherseal, comprising:
(a) a weatherseal body; and
(b) a powder coating on the weatherseal body, wherein the powder coating includes reflective particles.

10. The automotive weatherseal of claim 9, wherein the weatherseal body is a thermoset material and the powder coating comprises a thermoplastic material.

11. The automotive weatherseal of claim 9, wherein the powder coating is heat fusible.

13. The weatherseal of claim 9, wherein the powder coating comprises a thermoset.

14. The weatherseal of claim 9, wherein the powder coating comprises a thermoplastic.

15. The weatherseal of claim 9, wherein the weatherseal body includes a trim portion and the powder coating is located on the trim portion.

16. The weatherseal of claim 9, further comprising a metallic reinforcing member in the polymeric weatherseal body.

17. The weatherseal of claim 9, further comprising a sealing portion and a trim portion, wherein the trim portion is formed of a different material than the sealing portion, and the powder coating is on at least a portion of the trim portion.

18. An automotive weatherseal comprising;
(a) a weatherseal body; and
(b) a reflective powder coating on at least a portion of the weatherseal body.

19. The automotive weatherseal of claim 18, wherein the reflective powder coating is heat fusible.

20. The weatherseal of claim 18, wherein the reflective powder coating comprises a thermoset.

21. The weatherseal of claim 18, wherein the reflective powder coating comprises a thermoplastic.

22. The weatherseal of claim 18, wherein the polymeric weatherseal body includes a trim portion and the reflective powder coating is located on the trim portion.

23. The weatherseal of claim 18, further comprising a metallic reinforcing member in the polymeric weatherseal body.

24. The weatherseal of claim 18, further comprising a sealing portion and a trim portion, wherein the trim portion is formed of a different material than the sealing portion, and the reflective powder coating is on the trim portion.

25. An automotive weatherseal comprising a reflective cord extending along a length of the weatherseal.

26. The automotive weatherseal of claim 25, wherein the reflective cord includes a plurality of reflective filaments.

27. An automotive weatherseal comprising a reflective flock extending along a length of the weatherseal.

28. The automotive weatherseal of claim 27, wherein the reflective flock includes a flocked reflective material.

29. The automotive weatherseal of claim 27, wherein the reflective flock includes a non reflective material.

30. An automotive weatherseal comprising an extruded reflective surface extending along a length of the weatherseal.

31. An automotive weatherseal comprising a molded reflective surface.

32. The automotive weatherseal of claim 31, wherein the molded reflective surface substantially defines a cross section of the weatherseal.

33. A method of forming a vehicular weatherstrip comprising extruding a reflective extrudate to locate the reflective extrudate as a surface of a weatherseal body.

34. The method of claim 33, further comprising extruding the reflective extrudate and the weatherseal body to form an integral structure.

35. The method of claim 33, further comprising coextruding the reflective extrudate and the weatherseal body.

36. The method of claim 33, further comprising simultaneously extruding the reflective extrudate and the weatherseal body.

37. The method of claim 33, further comprising curing one of the reflective extrudate and the weatherseal body.

38. The method of claim 33, further comprising extruding the reflective extrudate onto a dynamic sealing portion of the weatherseal.

39. The method of claim 33, further comprising extruding one of a formed reflective tape and a formed reflective thread as the reflective extrudate.

40. The method of claim 33, further comprising extruding a formed reflective cloth as the reflective extrudate.

41. The method of claim 33 further comprising extruding the reflective extrudate as a portion of the weatherseal body.

42. A method of forming a weatherseal having a contact surface for engaging a panel, comprising:
(a) forming a mixture of a reflective material and a friction reducing material; and
(b) extruding the mixture onto at least a portion of the contact surface of the weatherseal.

43. The method of claim 42, wherein extruding the mixture includes coextruding the mixture with the contact surface.

44. A method of forming a weatherseal comprising impacting a multitude of reflective particles with an exposed surface of a weatherseal to retain at least a portion of the multitude of particles in the surface of the weatherseal.

45. The method of claim 44, further comprising incorporating the multitude of reflective particles with a bonding agent.

46. The method of claim 44, further comprising impacting the multitude of reflective particles with a bonding agent on the weatherseal.

47. A method of forming a weatherseal comprising molding a reflective material to form a portion of a cross section of the weatherseal, the reflective material forming a reflective surface of the weatherseal.

48. The method of claim 47, wherein the reflective material forms a majority of the cross section.

49. A method of forming a weatherseal comprising extruding a polymeric weatherseal body and applying a reflective textile to form an integral structure.

50. The method of claim 49, wherein applying the reflective textile includes applying a single reflective filament.

51. The method of claim 49, wherein applying the reflective textile includes extruding a reflective cloth.

52. The method of claim 49, wherein applying the reflective textile includes extruding a single reflective filament.

53. The method of claim 49, wherein applying the reflective textile includes simultaneously extruding a single reflective filament.

54. A method of forming a reflective surface on a weatherseal, comprising:
(a) retaining a reflective powder coating on the weatherseal; and
(b) colliquefying the retained reflective powder coating to form the reflective surface.

55. The method of claim 54, further comprising electrostatically retaining the reflective powder coating on the weatherseal.

56. The method of claim 54, further comprising forming the weatherseal of a polymeric material.

57. A method of forming a reflective surface film on a weatherseal, comprising:
(a) retaining a powder coating on the weatherseal; and
(b) colliquefying the retained powder coating to form the reflective surface film.

58. A method of forming a weatherseal comprising extruding a weatherseal body to incorporate a reflective material, the reflective material forming a reflective surface of the weatherseal.

59. The method of claim 58, further comprising forming a portion of the weatherseal of the reflective material.

60. The method of claim 58, further comprising forming one of a carrier portion, a trim portion and a sealing portion of the reflective material.
